(19) United States
(12) Patent Application Publication
(10) Pub. No.: US 2002/0125065 A1
(43) Pub. Date: Sep. 12, 2002

(54) Electronic apparatus having resonant panel-form loudspeaker

(76) Inventor: Graham Bank, Suffolk (GB)

Correspondence Address: Alan I. Cantor, FOLEY & LARDER, Washington Harbour, 3000 K Street, N.W., suite 500, Washigton, DC, 20007-5109, US

(21) Appl. No.: 09/729,668

(22) Filed: Dec. 5, 2000

Related U.S. Application Data
(63) Continuation of application No. PCT/GB99/01748, filed on Jun. 3, 1999.

(30) Foreign Application Priority Data
Jun. 5, 1998 (GB) 9812225.2

(51) Int. Cl. H04R 7/00; G10K 13/00

(52) U.S. Cl. 181/161; 181/171; 181/150

(57) ABSTRACT

Electronic apparatus having a support structure or casing and a loudspeaker attached thereto, the loudspeaker comprising a resonant panel-form member and a vibration exciter mounted to the panel-form member to apply bending wave energy thereto to cause the member to resonate to produce an acoustic output. The vibration exciter is grounded on the support structure or casing and is adapted to support the panel-form member on the support structure or casing, thus forming a mount for the panel-form member.

### FIELD OF THE INVENTION

This invention relates to acoustic devices and more particularly to resonant panel-form acoustic devices such as loudspeakers.

### BACKGROUND TO THE INVENTION

International patent application WO97/09842 describes resonant panel-form acoustic devices now known as ‘distributed mode’ or ‘DM’ devices including loudspeakers.

Particularly successful types and specific structures of transducers or vibration exciters for applying bending wave energy to panel-form members to cause resonance include those of so-called inertial nature.

It has been of particular practical value in prior distributed mode loudspeaker applications for the vibration exciters to be attached directly to loudspeaker panel members without need for additional support for the exciters. This practice is logical as well as successful in cases where the exciter mass is less than the mass of the panel member, including where the panel member is supported by local framing or some equivalent suspension. Also, such panel-suspended exciters have potential for beneficial resonance according to a second order characteristic effective to extend the low frequency response. A very different situation arises for much smaller distributed mode panel members, where a point can be reached at which panel member mass is of the same order or even less than that of the mass of the exciter, perhaps especially for electro-dynamic type exciters which have significant mass due to the magnet and magnet poles. Considerations of panel strength, resistance to impact shock etc. become important; and it is an object of this invention to provide a novel and advantageous solution.

### SUMMARY OF THE INVENTION

According to the invention a resonant panel-form acoustic device comprises a resonant panel-form member and a vibration exciter mounted to the panel-form member to apply bending wave energy thereto to cause the member to resonate to produce an acoustic output, wherein the vibration exciter is adapted to act as a carrier for the panel-form member. In this way the vibration exciter acts as a mount for the panel-form member, rather than the exciter being mounted on the panel-form member as was previously proposed. The vibration exciter may in turn be mounted on a host system, e.g. a loudspeaker stand or bracket or electronic apparatus such as a laptop computer.

In one embodiment, a small light distributed mode panel member is effectively free other than for its association with the vibration exciter which constitutes the means of mounting/attachment of the complete loudspeaker assembly.

Interestingly, for such a fixed or grounded vibration exciter, the high-pass function will now be first order, typically with a roll-off at about 6 dB/octave; and the panel member design in respect of local acoustic loading and lowest bending frequency can usefully be adjusted to take this into account. There is, of course, clear benefit where low frequency roll-off of about 6 dB/octave is a design objective.

Although the invention provides that the structure of the vibration exciter affords basic support and stability for a resonant panel member, particularly for light-weight panel members, additional framing and/or suspension of the panel member may be provided if appropriate and desired, whether for stability or for defining/controlling desired vibration conditions in/for the panel member, or both, perhaps particularly in or as to contributions of peripheral/marginal regions, including from partial up to substantially full sealing of the panel member into a baffle. The availability of additional acoustic control by separating the front acoustic output from the rear acoustic output of the panel may be beneficial in certain applications.

### BRIEF INTRODUCTION TO THE DRAWINGS

Exemplary specific implementation will now be described with reference to the accompanying diagrammatic drawings, in which:

FIGS. 1A,B and C are respectively a rear plan, and a partial sectional side view of a prior art resonant panel-form loudspeaker together with a graphical idealised acoustic output/response curve, and

FIGS. 2A to C correspond respectively to those of FIGS. 1A to 1C and show a resonant panel-form loudspeaker embodying the present invention.

### DESCRIPTION OF ILLUSTRATED EMBODIMENTS

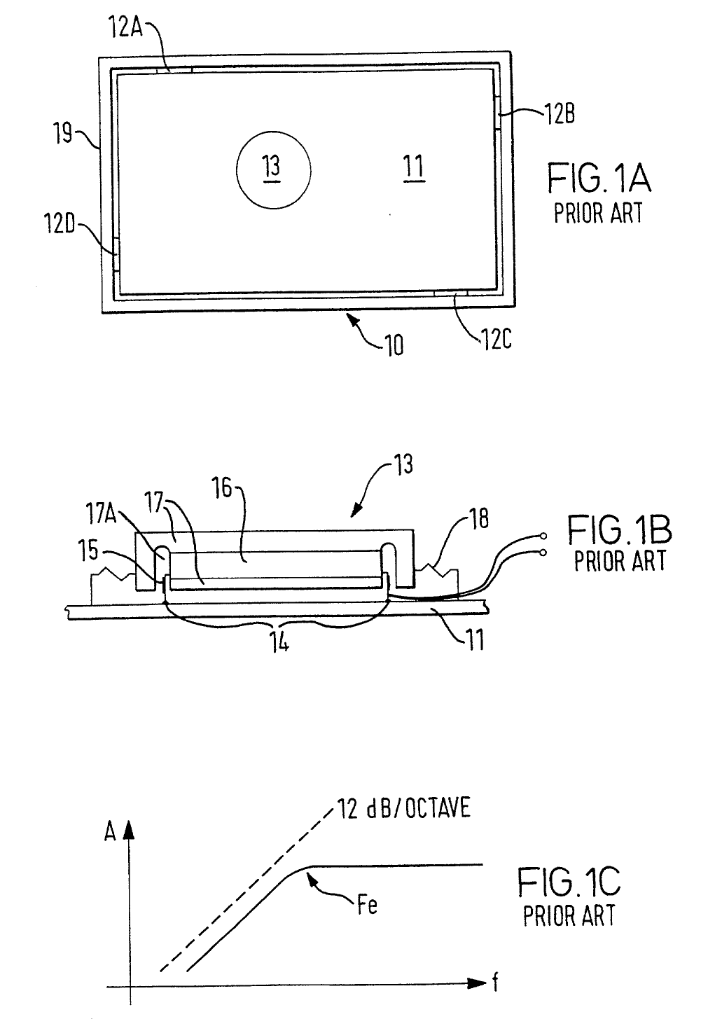

Referring first to FIGS. 1A-C, a prior art panel-form distributed mode loudspeaker 10 comprises a suitable resonant panel member 11 mounted at its edges by means of resilient suspension members 12A to D in a frame 19. An inertial electrodynamic vibration exciter 13 is shown mounted and supported wholly on the panel member 11 to excite the panel into resonance to produce an acoustic output.

Specifically, the exciter 13 comprises a moving coil 15 rigidly connected at connection 14 to the panel 11. The moving coil 15 is arranged in the annular gap 17A of a magnet assembly 16,17 comprising a magnet 16 sandwiched between a pair of pole-pieces 17 and having suitably compliant suspension 18 connected between the magnet assembly and the panel member 11. In general, the panel member 11 will have more, often significantly more, mass than the exciter 13, particularly the magnet assembly 16,17 as the highest mass component thereof. Indicated frequency-dependent roll-off of loudspeaker output A is at least 12 dB/octave below the region (Fe) of exciter resonance. Such an arrangement is disclosed in WO97/09842.

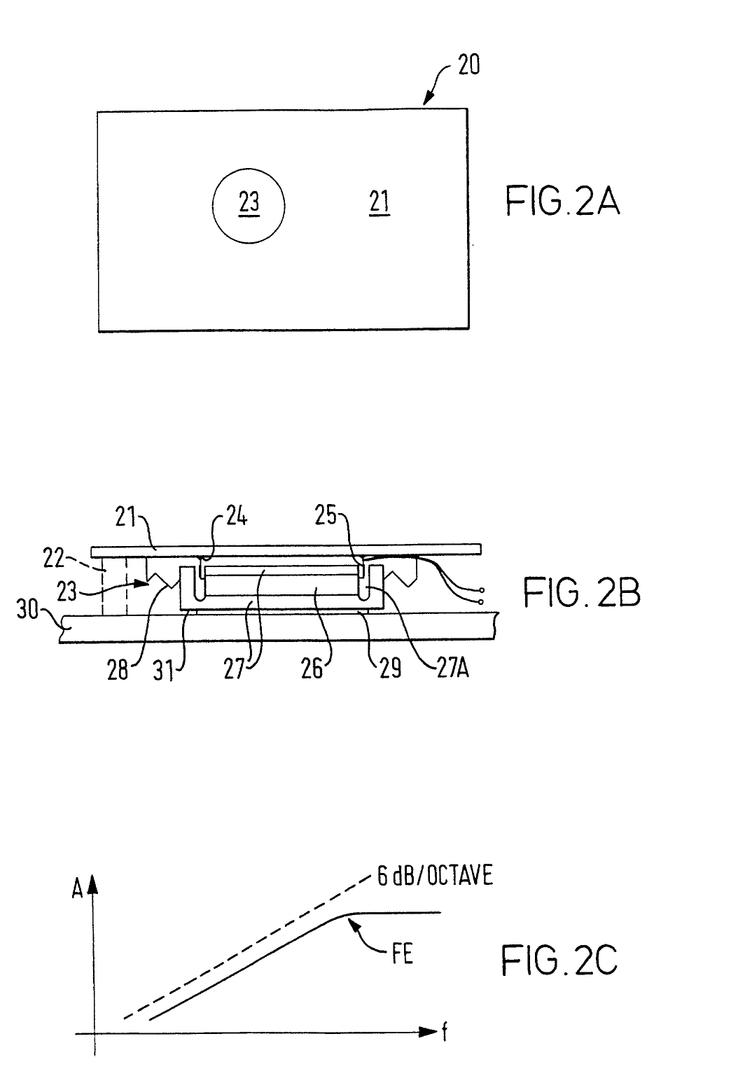

Turning to FIGS. 2A to C, a panel-form resonant loudspeaker 20 embodying this invention comprises a suitable resonant panel member 21 shown with a generally similar relationship with a vibration exciter 23 generally in accordance with the teaching in WO97/09842 and reference numerals 24 to 28 generally correspond to reference numerals 14 to 18 of FIG. 1B.

In this case, however, the panel member 21 is of the same order or even less mass than the exciter 23 or highest mass part(s) thereof, namely the magnet assembly comprising the magnet 26 and associated pole-pieces 27. The magnet assembly 26,27 is arranged actually to carry the panel member 21, rather than vice versa as is the case in the prior art arrangement. Moreover, the magnet assembly 26,27 is the means by which the loudspeaker 20 as a whole is mounted, see bond 29 between a rear face 31 of the exciter magnet assembly and a mounting structure 30 to support the loudspeaker in position on a host apparatus, e.g. a loudspeaker stand or the structure or casing of electronic apparatus.

As illustrated, and in complete contrast to practice hitherto, the panel member 21 is effectively free, i.e. not as such suspended to any support structure other than the exciter. If desired, however, soft resilient members 22 may be connected between the edges of the panel member 21 and the mounting structure 30 to damp excessive movements of the panel edges in use.

By way of specific example, a distributed mode panel member 21 measures 2 mm in thickness and approximately 2.5×3 cm in area, and weighs only a few grams (perhaps as little as two grams or even less) compared with an electro-dynamic exciter 23 at up to about 15 grams or more. A serviceable and reliable loudspeaker assembly was designed by adhesively fixing the back face 31 of the exciter magnet assembly to a suitable area of the host apparatus (in this case the interior face of the lid of a laptop computer) and allowing the panel to operate freely on the coil suspension of the exciter. The loudspeaker was obscured behind a grille in the lid.

The damping and related material properties of this DM panel can particularly suit use as described, its smallness giving rise to boundary conditions in the exciter region which provide some modal termination which by prior practice would have had to be otherwise provided-for at peripheral regions of a mounted or suspended panel.

It is, of course, feasible for some degree of ancillary mounting and/or other association of the panel member 21 with other damping and/or framing means, including in association with a baffle.

As shown in FIG. 2C, it is particularly noteworthy that low frequency roll-off is now much more gradual, specifically at about 6 dB/octave.

1. A resonant panel-form acoustic device comprising a resonant panel-form member and a vibration exciter mounted to the panel-form member to apply bending wave energy thereto to cause the member to resonate to produce an acoustic output, wherein the vibration exciter is adapted to act as a carrier for the panel-form member.

2. A resonant panel-form acoustic device according to claim 1, wherein the vibration exciter is adapted for mounting on a host system.

3. A resonant panel-form acoustic device according to claim 1 or claim 2, comprising a moving coil electro-dynamic vibration exciter having a magnet assembly and a voice coil movable with respect to the magnet assembly in response to an applied electrical signal, the resonant panel-form member being rigidly coupled directly to the voice coil, and comprising resilient suspension means coupled between the panel-form member and the magnet assembly to support the panel-form member.

4. A resonant panel-form acoustic device according to claim 3, wherein the magnet assembly has a face adapted to be rigidly fixed to a host system.

5. A resonant panel-form acoustic device according to any one of claims 2 to 4, comprising damping means applied between the panel-form member and the host system.

6. A loudspeaker comprising a resonant panel-form acoustic device as claimed in any preceding claim.

7. Host system comprising a loudspeaker as claimed in claim 6.

8. A laptop computer comprising a loudspeaker as claimed in claim 6.
